(19) United States
(12) Patent Application Publication
(10) Pub. No.: US 2021/0193409 A1
(43) Pub. Date: Jun. 24, 2021

(54) PRESS-KEY WITH MULTIPLE-TRIGGER MECHANISM

(71) Applicants: DONGGUAN SOLIDTEK ELECTRONICS CO., LTD., DONGGUAN CITY (CN); SOLID YEAR CO., LTD., NEW TAIPEI CITY (TW)

(72) Inventors: TIEN-HAO YANG, NEW TAIPEI CITY (TW); YUAN-ZHANG LIU, DONGGUAN CITY (CN)

(21) Appl. No.: 17/036,899

(22) Filed: Sep. 29, 2020

(30) Foreign Application Priority Data
Dec. 18, 2019 (TW) 108216801

(51) Int. Cl. H01H 13/20; H01H 13/10; H01H 13/14; H01H 13/50

(52) U.S. Cl. CPC H01H 13/20; H01H 13/10; H01H 2233/07; H01H 13/50; H01H 13/14

(57) ABSTRACT

A press-key with a multiple-trigger mechanism includes a base, an alphanumeric key assembly, and at least two elastic members. The alphanumeric key assembly includes a coupling assembly provided on the base. The at least two elastic members are provided on the base and under the alphanumeric key assembly. One of the elastic members has a different height from the remainder of the elastic members. When the alphanumeric key assembly is moved toward the base, the elastic members are separately driven by the alphanumeric key assembly to press and thereby activate a switch such that different electrical signals are generated. The operability and trigger response of the press-key can be flexibly adjusted according to user needs so that the press-key can be operated rapidly and respond in real time.

### BACKGROUND OF THE INVENTION

### 1. Field of the Invention

The present invention relates to a press-key and more particularly to a press-key that has a multiple-trigger mechanism.

### 2. Description of the Related Art

A present-day computer as well as a traditional typewriter requires a keyboard with which to input instructions. With the advancement of technology and as user needs vary, keyboards have been provided with various additional functions and different configurations.

Generally, a keyboard regardless of its configuration includes a plurality of press-keys, and each press-key can be pressed down to drive an internal elastic member and thereby trigger a sensitive switch so that a press on the key generates an electrical signal.

Furthermore, keyboards have been used in conjunction with a great diversity of application software. Game software, for example, requires press-keys to be able to be operated rapidly and respond in real time. The simple press-key structure described above, however, often fails to satisfy the foregoing requirements of game software, thus restricting the applicability of keyboards with such press-keys.

### SUMMARY OF THE INVENTION

The primary objective of the present invention is to provide a press-key whose operability and trigger response can be flexibly adjusted according to user needs so as to be able to be operated rapidly and respond in real time.

To achieve the above objective, the present invention provides a press-key that has a multiple-trigger mechanism. The press-key includes a base, an alphanumeric key assembly, and at least two elastic members. The base is provided with a switch. The alphanumeric key assembly is provided above the base and includes a coupling assembly provided on the base. The at least two elastic members are provided on the base at positions under the alphanumeric key assembly, and one of the at least two elastic members has a different height from the remainder of the at least two elastic members. When the alphanumeric key assembly is moved toward the base, the at least two elastic members are separately driven by the alphanumeric key assembly to press and thereby activate the switch such that different electrical signals are generated. The operability and trigger response of the press-key can be flexibly adjusted according to user needs in order to enable the press-key to be operated rapidly and respond in real time.

Preferably, the coupling assembly is a scissor-leg assembly.

Preferably, the alphanumeric key assembly includes a keycap, and one of the at least two elastic members is provided at a position under the keycap.

Preferably, one of the at least two elastic members is provided at a position under the coupling assembly.

The detailed structure or features provided by the present invention will be described in the detailed description of the subsequent implementation. As a person of ordinary skill in the art would understand, the detailed description and the specific embodiment provided herein serve only to expound the invention and are not intended to limit the scope of the patent protection sought by the applicant.

### BRIEF DESCRIPTION OF THE DRAWINGS

FIG. 1 is an exploded perspective view of a preferred embodiment of the present invention.

FIG. 2 is an assembled front view of the preferred embodiment in FIG. 1.

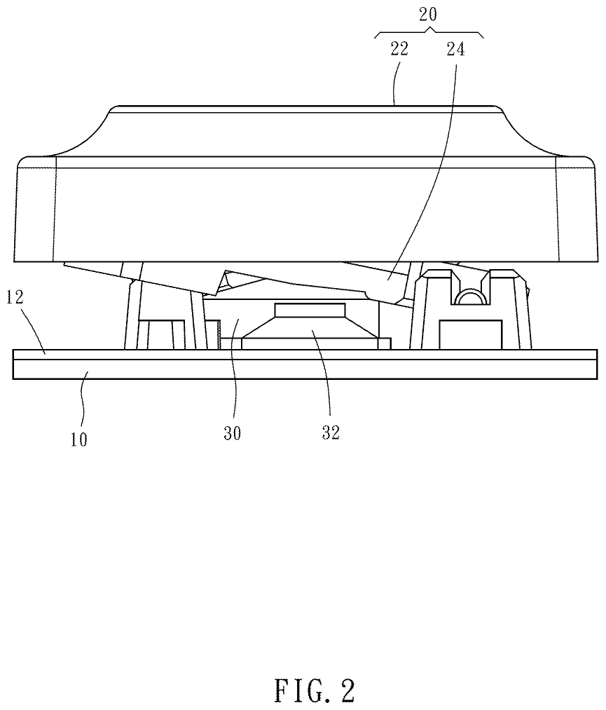

FIG. 3 is an assembled sectional view of the preferred embodiment in FIG. 1.

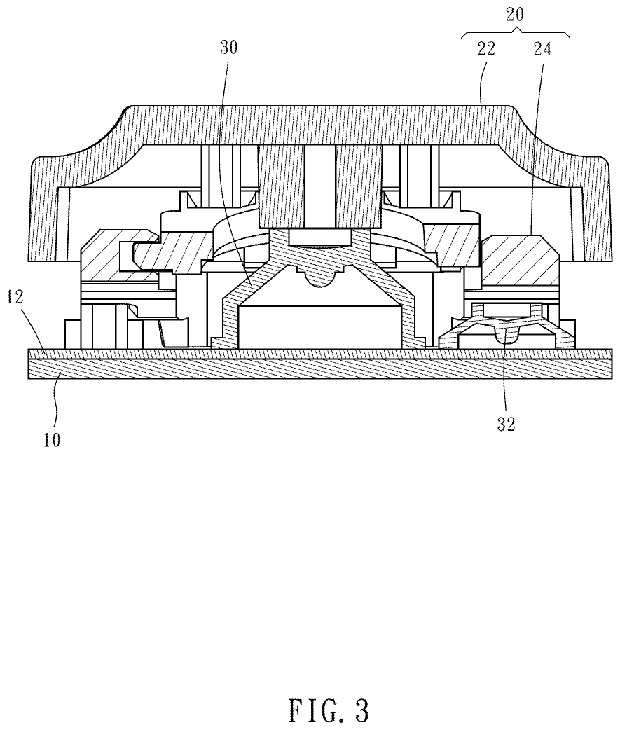

### DETAILED DESCRIPTION OF THE INVENTION

The technical contents and features of the present invention are detailed below with reference to a preferred embodiment in conjunction with the accompanying drawings. The invention can be applied to keyboards of various types and in different application fields. As a person of ordinary skill in the art would understand, the terminology used in this section of the specification includes superordinate terms, whose application fields are subject to no limitations. For example, a term that is used to specify a material or shape refers to but is not limited to the material or shape specified. The same applies to such positional terms as “provided”, “near”, “connected to”, and “adjacent to”. The indefinite article “a” may connote plurality as well as singularity in terms of the quantity of a component. Directional terms such as “upper”, “lower”, “inner”, “outer”, “top”, and “bottom” make reference to directions in normal use and serve illustrative purposes only; they are not intended to be restrictive of the scope of the invention.

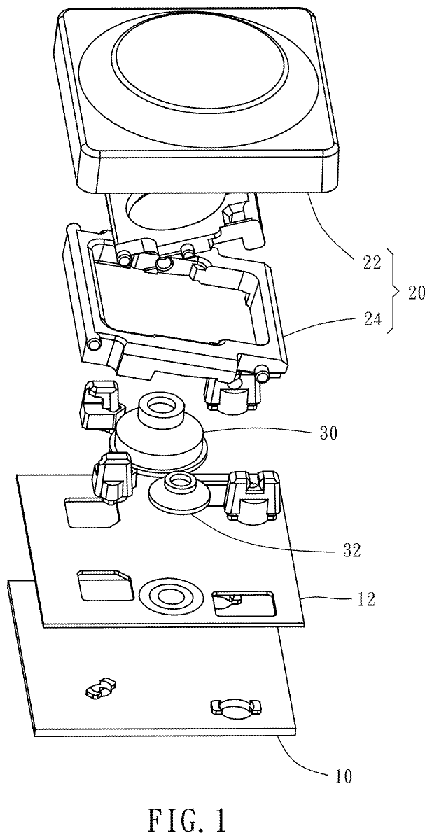

Referring to FIG. 1, a press-key with a multiple-trigger mechanism according to the present invention includes a base 10. In this preferred embodiment, the base 10 is a plate by way of example, with a membrane switch 12 provided on the surface of the base 10. An alphanumeric key assembly 20 is provided above the base 10. The alphanumeric key assembly 20 includes a keycap 22 and a coupling assembly 24. The coupling assembly 24 is provided between the base 10 and the keycap 22. In this preferred embodiment, the coupling assembly 24 is a scissor-leg assembly by way of example.

The press-key further includes at least two elastic members. In this preferred embodiment and by way of example, the at least two elastic members include two protruding elastic members that are made of silicone, namely a first elastic member 30 and a second elastic member 32. The first elastic member 30 and the second elastic member 32 are different in height and are both provided on the base 10 at positions under the alphanumeric key assembly 20. More specifically, the first elastic member 30 corresponds in position to the center of the keycap 22 and of the coupling assembly 24, and the second elastic member 32 is adjacent to the first elastic member 30 and under the coupling assembly 24.

The foregoing components are so designed that when the keycap 22 is pressed and thereby moved toward the base 10, the coupling assembly 24 is simultaneously driven downward by the keycap 22. The coupling assembly 24 is pressed on the second elastic member 32 to begin with, and the second elastic member 32 in turn is pressed on and thereby activates the membrane switch 12. The keycap 22 is subsequently pressed on the first elastic member 30 such that the first elastic member 30 is pressed on and thereby activates the membrane switch 12. As the alphanumeric key assembly 20 drives the second elastic member 32 and the first elastic member 30 to press and thereby activate the membrane switch 12 sequentially, the membrane switch 12 generates different electrical signals that have a time difference therebetween. A control circuit can identify such time differences and have different functions triggered accordingly. Thus, the present invention has the technical feature of enabling multiple triggering actions to be carried out through a single alphanumeric key assembly, and has therefore achieved the technical objective of providing a press-key whose operability and trigger response can be flexibly adjusted according to user needs so as to be able to be operated rapidly and respond in real time.

It is worth mentioning that the at least two elastic members can be adjusted to adapt to different applications. For example, all the elastic members may be pressed by the keycap in order to generate electrical signals having a time difference therebetween, or one of the elastic members is pressed by the keycap while the remainder of the elastic members is pressed by the coupling assembly. In either case, the objective of the present invention can be achieved.

What is claimed is:

1. A press-key with a multiple-trigger mechanism, comprising:
a base provided with a switch;
an alphanumeric key assembly provided above the base, wherein the alphanumeric key assembly includes a coupling assembly provided on the base; and
at least two elastic members provided on the base at positions under the alphanumeric key assembly, wherein one of the at least two elastic members has a different height from the remainder of the at least two elastic members such that when the alphanumeric key assembly is moved toward the base, the at least two elastic members are separately driven by the alphanumeric key assembly to press and thereby activate the switch so as to generate different electrical signals.

2. The press-key with a multiple-trigger mechanism as claimed in claim 1, wherein the coupling assembly is a scissor-leg assembly.

3. The press-key with a multiple-trigger mechanism as claimed in claim 1, wherein the alphanumeric key assembly comprises a keycap, and one of the at least two elastic members is provided at a position under the keycap.

4. The press-key with a multiple-trigger mechanism as claimed in claim 1, wherein one of the at least two elastic members is provided at a position under the coupling assembly.
